(19) United States
(12) Patent Application Publication
(10) Pub. No.: US 2024/0017100 A1
(43) Pub. Date: Jan. 18, 2024

(54) POLYPROPYLENE AND POLYTETRAFLUOROETHYLENE COMBINATION FACE MASK

(71) Applicants: Patrice Barbeau, Louiseville (CA); Luc Girard, Louiseville (CA); Dany BERGERON, Louiseville (CA); Genevieve HARDY, Louiseville (CA)

(72) Inventors: Patrice Barbeau, Louiseville (CA); Luc Girard, Louiseville (CA); Dany BERGERON, Louiseville (CA); Genevieve HARDY, Louiseville (CA)

(21) Appl. No.: 18/256,363

(22) PCT Filed: Dec. 8, 2021
(86) PCT No.: PCT/CA2021/051763

§ 371 Date: Jun. 7, 2023

Related U.S. Application Data
(60) Provisional application No. 63/122,759, filed on Dec. 8, 2020.

(51) Int. Cl. A62B 23/02; B32B 27/32; B32B 7/05; B32B 27/08; B32B 3/26; A41D 13/11; B32B 3/08; A62B 18/08

(52) U.S. Cl. CPC A62B 23/025; B32B 27/322; B32B 7/05; B32B 27/08; B32B 3/266; A41D 13/1115; B32B 3/08; A62B 18/08; B32B 2307/7242; B32B 2307/412; B32B 2250/242; B32B 2535/00; A41D 13/1161; B32B 2250/03; B32B 2270/00

(57) ABSTRACT

A face mask including a first polypropylene outer layer, a second polypropylene outer layer, a combination polytetrafluoroethy lene and polypropylene inner layer arranged between the first and second polypropylene outer layers, and at least one strap fixed to an outside surface of one of the outer layers. Also, a facemask having the aforementioned structure and also including a transparent window.

### FIELD

The present invention relates to a polypropylene (PP) and polytetrafluoroethylene (PTFE), multilayered mask. One embodiment also relates to a polypropylene (PP) and polytetrafluoroethylene (PTFE), multilayered mask having a transparent window therein.

### BACKGROUND

SARS-CoV-2 or COVID-19 is a rapidly transmissible and highly infectious virus that was first detected in China in December 2019. Since its discovery, it has spread all over the world infecting 266 million individuals and counting. Currently, as of Dec. 1, 2021, COVID-19 has killed 5.2 million people world-wide. To avoid a complete lockdown and to prevent increased transmission of the virus, various countries have instituted and/or reinstituted mask mandates requiring various degrees of compliance in public spaces, such as requiring masks in all indoor facilities, and in more populated areas, even when outside in public.

As of Dec. 3, 2021, COVID-19 has mutated into two new strains, the Delta variant which dominated 2021 and the Omicron variant that was newly discovered in late November 2021. Compared to the original strain of COVID-19, the Delta variant has been shown to have increased transmissibility, and preliminary information has also predicted that the Omicron variant also has increased transmissibility.

Personal protective equipment (PPE) has long included facial coverings within the art. PPE face masks have traditionally been worn in medical facilities to avoid transmitting diseases to high-risk patients. PPE face masks are considered best practice for surgical procedures to preserve a sterile environment while decreasing the risk of infection. Widespread and public use of face masks was first used in eastern-Asian countries and has now become commonplace worldwide in view of COVID-19. In view of the new variations of COVID-19 and their increased transmissibility, PPE has become a primary method of reducing transmission.

Meltblown polypropylene is used as the middle layer of many certified medical masks and in the manufacture of respirators such as N95s. These masks contain a layer of many layers of fine woven polypropylene which is electrostatic and greatly aids in trapping air particulates. However, polypropylene masks usually are only effective for about four hours as the built-up humidity from a user's respiration will nullify the electrostatic properties of polypropylene.

Previously designed surgical face masks include versions with a transparent section arranged over the user's mouth. These face masks are arranged to secure to a user via a head strap fixed to the outside surface of the face mask and additionally comprises a filtration portion that may or may not have anti-microbial materials integrated within the filtration portion. However, the efficacy of these facemasks that include transparent windows may not meet certain required standards for medical providers. Such standards include Health Canada and ASTM International, previous known as the American Society for Testing and Materials.

Thus, there is a long-felt need for a face mask that has superior blood and fluid resistance while still maintaining breathability and dryness after prolonged use that complies with the ASTM International standards and Health Canada standards. Further, there is also a long-felt need for a face masking having the above-mentioned properties and configured to have a transparent portion where a user's mouth is visible in compliance with ASTM International standards and Health Canada standards.

### SUMMARY

The present invention generally comprises a first polypropylene outer layer, a second polypropylene outer layer, a combination polytetrafluoroethylene and polypropylene inner layer arranged between the first and second polypropylene outer layers, and at least one strap fixed to an outside surface of one of the outer layers.

The present invention also generally comprises a first polypropylene outer layer having an aperture, a second polypropylene outer layer having an aperture, a combination polytetrafluoroethylene and polypropylene inner layer having an aperture arranged between the first and second polypropylene outer layers, a transparent window arranged to overlap the apertures of the outer layers and the inner layer, the transparent window fixedly secured to an external surface of the first polypropylene outer layer, and at least one strap fixed to an external surface of one of the outer layers.

A general object of the present invention is to provide a face mask that provides filtration when the mask has accumulated humidity from extended user respiration over four hours.

A further object of the present invention is to provide a face mask that includes a transparent portion to allow visibility of a user's mouth that increases audibility and aesthetically is more appealing in settings where a user communicates frequently.

Another object of the present invention is to provide a face mask that has specific folding or pleat geometry that increases the distance of the inside surface of the face mask and a window therein from the user's mouth, to improve audibility and general comfort.

A still further object of the present invention is to provide a face mask that is compliant with ASTM F2100-19 Level 2 and 3 compliance levels.

An even further objection of the present invention is to provide a face mask that is compliant with Health Canada standards.

These and other objects, features, and advantages of the present invention will become readily apparent upon a review of the following detailed description of the invention, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a front-left perspective view of the first embodiment of the present invention in use;

FIG. 2 is a front-right perspective view of the second embodiment of the present invention in use;

FIG. 3A is a perspective view of the first embodiment of the present invention in a non-pleated configuration;

FIG. 3B is a perspective view of the first embodiment of the present invention in a pleated configuration;

FIG. 4A is a perspective view of the second embodiment of the present invention in a non-pleated configuration;

FIG. 4B is a perspective view of the second embodiment of the present invention in a pleated configuration also showing a focused view of the pleated arrangement;

FIG. 5A is a cross-sectional view of the first embodiment of the present invention in a non-pleated configuration taken along lines 5A-5A shown in FIG. 3A;

FIG. 5B is a cross-sectional view of the second embodiment of the present invention in a non-pleated configuration taken along lines 5B-5B shown in FIG. 4A;

FIG. 6 is an exploded view of the first embodiment of the present invention; and,

FIG. 7 is an exploded view of the second embodiment of the present invention.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims.

It should also be appreciated that the directional terms, e.g., “upward”, “top”, “downward”, “bottom”, “rightward”, “leftward”, and similar variations thereof, pertain to the corresponding figures described herein as they are illustrated. For example, “component X being positioned rightwardly relative to component Y”, means that “component X” is located to the right of “component Y” with respect to the drawing to which it pertains.

It should also be further appreciated that polypropylene will be referenced as “PP” herein and after. Also, polytetrafluoroethylene will be referenced as “PTFE” herein and after.

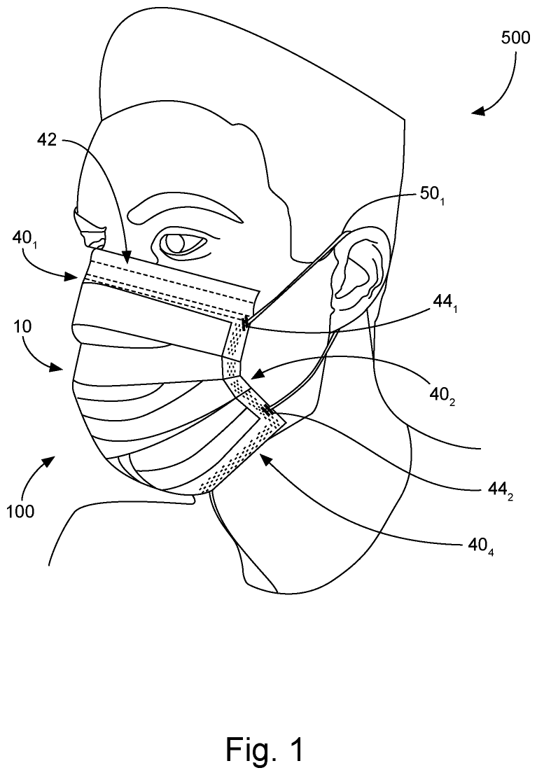

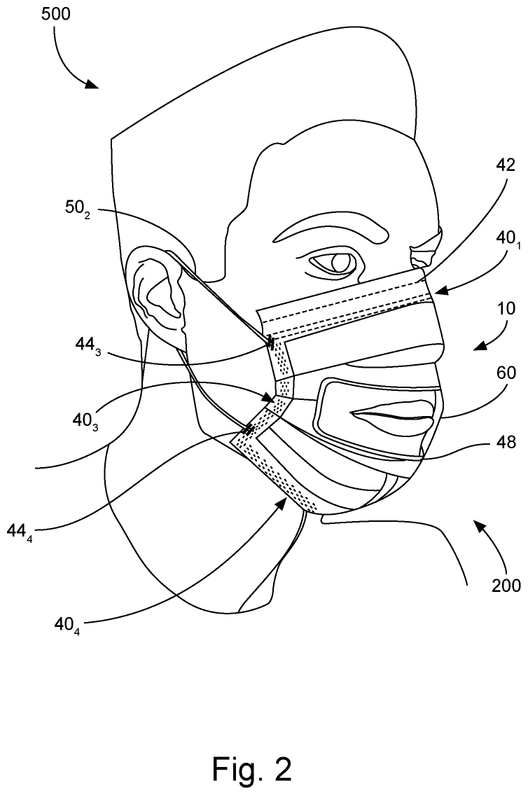

Adverting now to the figures, FIG. 1 is a front left perspective view of a first embodiment of the present invention in use. User 500 is illustrated wearing PP and PTFE combination face mask 100 (hereinafter “mask 100”). Mask 100 is secured to a user's face via ear loops 50i and 50₂ (50₂ is shown in FIG. 2 in view of mask 200). It should be appreciated that, although the embodiment illustrated in FIG. 1 shows mask 100 secured around a user's ears via ear loops 50₂ and 50₂, alternatively, ear loops 50₂ and 50₂ may be configured to rest around the back of the user's neck and head. It should also be appreciated that, although the exemplary illustration of the present invention depicts a pair of ear loops, it is contemplated that a third strap may also be included to create a greater seal around a user's nose and mouth. Ear loop 50₁ is secured to mask 100 via ultrasonic welds 44₁ and 44₂. First outer layer 10 of mask 100 faces away from the face of user 500. Mask 100 comprises three layers that are welded together by ultrasonic welding. In a preferred embodiment, mask 100 comprises four ultrasonic welds 40₁, 40₂, 40₃ (shown in FIG. 2), and 40₄ which define a perimeter of the mask. The welds function to provide the best fluid resistance, bacterial filtration efficiency, particulate filtration efficiency, and breathability (when the nasal and oral passageways are covered by mask 100). The specific standard requirements of each of these categories, along with the efficacy provided by mask 100 are described infra.

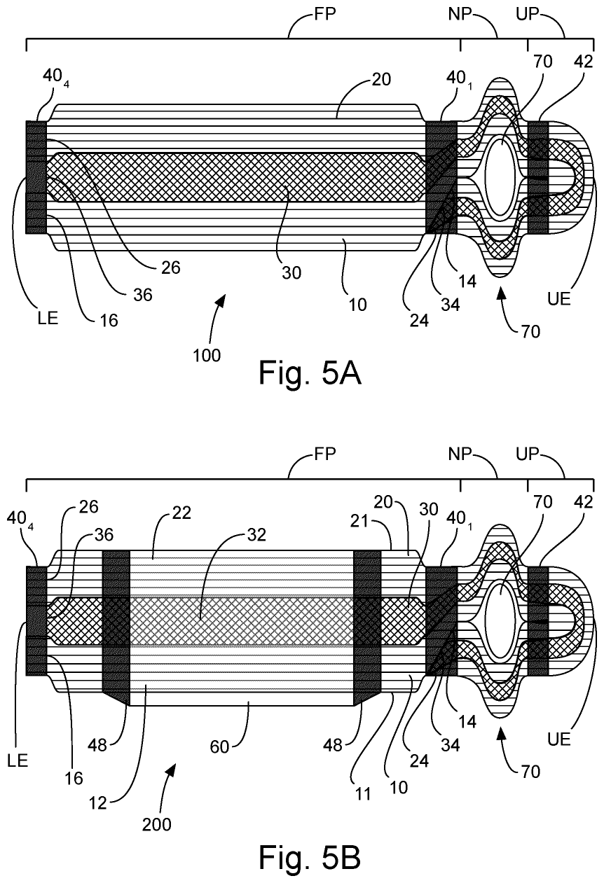

It should be appreciated that mask 200 includes all the components of mask 100 and is rotated in FIG. 2 to show the right side of user 500. FIG. 2 is a front left perspective view of the second embodiment of the present invention in use. PTFE and PP combination face mask with transparent window 200 (hereinafter “mask 200”) also comprises window 60 and an aperture provided within each of the three layers of mask 200, discussed in view of FIG. 5B, infra. Window 60 is fixedly secured to first outer layer 10 of mask 200 via window ultrasonic weld 48 which circumscribes the outer perimeter of window 60. The specific standard requirements of each of these categories, along with the efficacy provided by mask are described infra. FIG. 2 also shows ultrasonic welds 40₃ and 40₄ that are arranged to fix ear loop 50₂ to first outer layer 10 of mask 200. It should be appreciated that ultrasonic welds 40₃, 40₄, and ear loop 50₂ are also present on mask 100, as shown in FIG. 1.

Mask 200 allows the mouth of user 500 to be seen through window 60, making verbal communication easier, i.e., allowing lip-reading. Window 60 is preferably a plastic material having anti-fog attributes and, in a preferred embodiment, is made of polyethylene. This is helpful in decreasing social intimidation that can be experienced in young children's classrooms throughout COVID-19 masking procedures, where a teacher and students are able to see each others' mouths, or in other situations such as occupation therapy settings or mental disability settings. Window 60 may serve a security purpose to identify user 500 more easily behind mask 200 in a setting where user 500 may need to produce identification for entry and temporary removal of a mask may be prohibited, e.g., hazardous chemical or biologic labs, or where removal is unnecessarily risky, e.g., immunocompromised individuals.

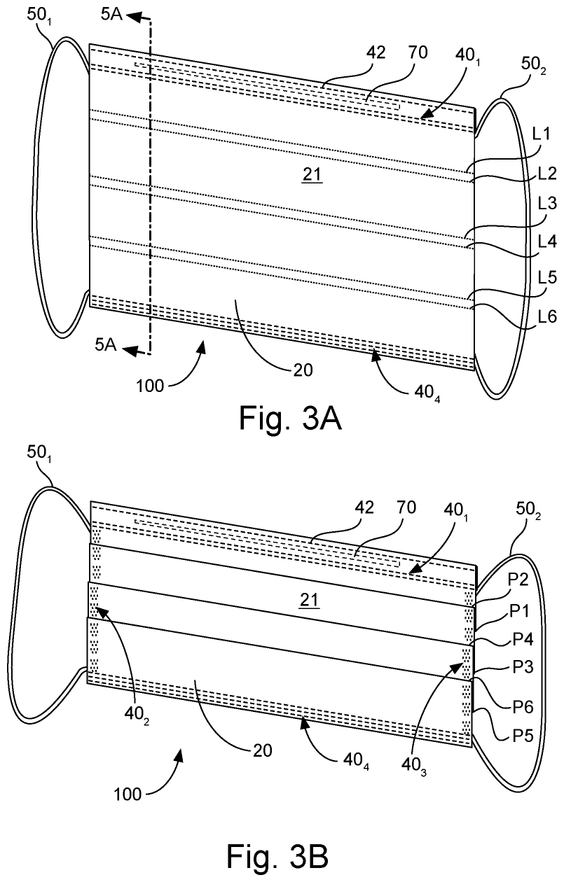

The following description should be taken in view of FIGS. 3A and 3B. FIG. 3A is a perspective rear view of mask 100 in a non-pleated configuration and FIG. 3B is a perspective rear view of mask 100 in a pleated configuration. FIGS. 3A and 3B show the inside of mask 100, that is, face surface 21 of second outer layer 20. In a preferred embodiment, mask 100 is arranged to be worn with second outer layer 20 proximate to a user's face, such that various bodily structures, e.g., nose, chin, cheeks, may contact face surface 21 of second outer layer 20. Located proximate the top of mask 100 are upper ultrasonic weld 40₁ and sleeve ultrasonic weld 42, which both fix all three layers of mask 100 together (shown in FIGS. 5A and 5B). Located proximate the bottom of mask 100 is lower ultrasonic weld 40₄. upper ultrasonic weld 40₁, lower ultrasonic weld 40₄, and sleeve ultrasonic weld 42, collectively secure all three layers of mask 100 together at the top and bottom of mask 100 (shown in greater detail in FIG. 5A). Ear loops 50₁ and 50₂ are arranged to secure mask 100 to a user's face, as illustrated in FIG. 1. Ultrasonic weld 40₁ and sleeve ultrasonic weld 42 hold nosepiece 70 in place (also shown FIG. 5A). Nosepiece 70 is comprised of a deformable material, e.g., thin metal or plastic-coated metal.

To fully secure all three layers of mask 100 together, first side ultrasonic weld 40₂ and second side ultrasonic weld 40₃ are applied to the sides of mask 100. First side ultrasonic weld 40₂ and second side ultrasonic weld 40₃ also function to pleat mask 100 by creating pleats P1-P6. Pleats P1-P6 are all folds on fold lines L1-L6. Fold lines L1, L3, and L5 create pleats P1, P3, and P5, respectively, and are all upward folds, that is, mask 100 is folded upwardly (weld 40₄ is folded in a direction towards weld 42) and into face surface 21. Fold lines L2, L4, and L6 create pleats P2, P4, and P6, respectively, and are all downward folds (weld 40₄ is folded in a direction away from weld 42), that is, mask 100 is folded downwardly and away from face surface 21. Pleats P1-P6 create pinch points at their respective ends via first side ultrasonic weld 40₂ and second side ultrasonic weld 40₃. When mask 100 is expanded and worn, as shown in FIG. 1, mask 100 expands outwardly and away from a user's face by pleats P1-P6 unfolding at substantially central locations between first side ultrasonic weld 40₂ and second side ultrasonic weld 40₃ while the ends of pleats P1-P6 remain folded at first side ultrasonic weld 40₂ and second side ultrasonic weld 40₃. The unfolding increases comfort and audibility. Additionally, the distance from a user's face and face surface 21 from pleats P1-P6 also functions to protect individuals from sanitary skin damage, such as a rash, or cosmetic blemishes that face surface 21 could cause to makeup from resting on a user's face.

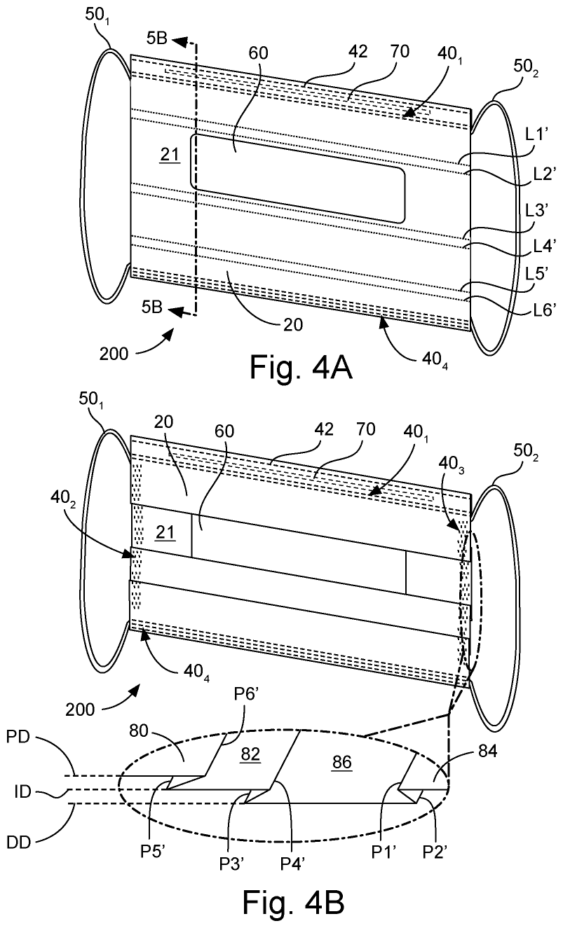

The following description should be taken in view of FIGS. 4A and 4B. FIG. 4A is a perspective view of mask 200 in a non-pleated configuration and FIG. 4B is a perspective view of mask 200 in a pleated configuration. FIGS. 3A and 3B show the inside of mask 200, that is, face surface 21 of second outer layer 20. In a preferred embodiment, mask is arranged to be worn with second outer layer 20 proximate to a user's face, such that various bodily structures, e.g., nose, chin, cheeks, may contact face surface 21 of second outer layer. Located proximate to the top of mask 200 are upper ultrasonic weld 40₁ and sleeve ultrasonic weld 42, which both fix all three layers of mask 200 together (shown in FIG. 5B). Located proximate to the bottom of mask 200 is lower ultrasonic weld 40₄. Upper ultrasonic weld 40₁, lower ultrasonic weld 40₄, and sleeve ultrasonic weld 42, collectively secure all three layers of mask 100 together at the top and bottom of mask 200 (shown in greater detail in FIG. 5B). Ear loops 50₁ and 50₂ are arranged to secure mask 200 to a user's face, as illustrated in FIG. 2. Ultrasonic weld 40₁ and sleeve ultrasonic weld 42 hold nosepiece 70 in place (also shown FIG. 5B). Nosepiece 70 is comprised of a deformable material, e.g., thin metal or plastic-coated metal. Mask 200 also includes window 60 which in a preferred embodiment is arranged at a substantially horizontal central location and is arranged vertically and proximate to upper ultrasonic weld 40₁ than lower ultrasonic weld 40₄.

To fully secure all three layers of mask 200 together, first side ultrasonic weld 40₂ and second side ultrasonic weld 40₃ are applied to the sides of mask 200. First side ultrasonic weld 40₂ and second side ultrasonic weld 40₃ also function to pleat mask 200 by creating pleats P1′-P6′. Pleats P1′-P6′ are all folds on fold lines L1′-L6′, respectively. Fold lines L1′, L3′, and L5′ create pleats P1′, P3′, and P5′, respectively. Fold line L1′ is an upward fold, that is, mask 200 is folded upwardly and away from face surface 21 and fold lines L3′ and L5′ are upward folds, that is, mask 200 is folded upwardly and into face surface 21. Fold lines L2′, L4′, and L6′ create pleats P2′, P4′, and P6′, respectively. Fold line L2′ is a downward fold, that is, mask 200 is folded downwardly and into face surface 21. Fold lines L4′ and L6′ are downward folds, that is, mask 200 is folded downwardly and away from face surface 21. Pleats P1′-P6′ create pinch points at their respective ends via first side ultrasonic weld 40₂ and second side ultrasonic weld 40₃. When mask 100 is expanded and worn, as shown in FIG. 2, mask 200 expands outwardly and away from a user's face by pleats P1′-P6′ unfolding at a substantially central location in between first side ultrasonic weld 40₂ and second side ultrasonic weld 40₃ while the ends of pleats P1′-P6′ remain folded at first side ultrasonic weld 40₂ and second side ultrasonic weld 40₃. The unfolding increase comfort and audibility. Additionally, pleats P1′-P6′ create a distance between window 60 and a user's face. This distance also functions to protect individuals from sanitary skin damage, such as a rash, or cosmetic blemishes that face surface 21 and/or window 60 could cause to makeup from resting on a user's face.

Pleats P1′-P6′ create four (4) panels within mask 200: lower boundary panel 80, connecting panel 82, upper boundary panel 84, and window panel 86. Lower boundary panel 80 is defined by the edge of mask 200 proximate to lower ultrasonic weld 40₄ and pleat P6′, connecting panel 82 is defined by pleats P5′ and P4′, upper boundary panel 84 is defined by the edge of mask 200 proximate to weld 42 and pleat P1′, and window panel 86 is defined by pleats P2′ and P3′. Window panel 60 is contained within window panel 86 and is arranged to be located on the panel that is farthest from a user's mouth or face. Pleats P1′-P6′ create three (3) different depths of panels 80-86. Lower boundary panel 80 is arranged at a proximal depth PD. Connecting panel 82 and upper boundary panel 84 are arranged at intermediate depth ID. Window panel 86 is arranged at distal depth DD, where distal depth DD is arranged at the farthest distance away from a user's mouth and face—increasing comfort for extended periods of use.

FIG. 5A is a cross sectional view of mask 100 taken along line 5A-5A shown in FIG. 3A. Specifically, FIG. 5A is an exaggerated cross section view of mask 100 to properly illustrate the layering and positioning of the various components. First outer layer 10 is the layer of mask 100 that faces away from a user's face and second outer layer 20 is the layer of mask 100 that is proximate to a user's face. Inner layer 30 is sandwiched between first outer layer 10 and second outer layer 20. Upper ultrasonic weld 40₁ and lower ultrasonic weld 40₄ fix layers 10, 20, and 30 together, specifically, lower end 16 of first outer layer 10, lower end 36 of inner layer 30, and lower end 26 of second outer layer 20 are fixed by lower ultrasonic weld 40₄. In a preferred embodiment, upper ultrasonic weld 40₁ fixes layers 10, 20, and 30 and their respective upper ends: upper end 14 of first outer layer 10, upper end 34 of inner layer 30, and upper end 24 of second outer layer 20, together, such that nosepiece sleeve 72 is formed from the excess length between layers 10, 20, and 30 at upper ultrasonic weld 40₁ and upper ends 14, 24, and 34. Nosepiece sleeve 72 creates pocket 74, that is arranged to hold nosepiece 70 therein. Pocket 74 is made tighter via sleeve ultrasonic weld 42 to hold nosepiece 70 that limits vertical movement within pocket 74.

In reference to both FIGS. 5A and 5B, masks 100 and 200 are defined by three sections: filtration section FS; nosepiece section NS; and, upper section US. Filtration section FS is defined by the distance between by lower end 16 of first outer layer 10, lower end 36 of inner layer 30, and lower end 26 of second outer layer 20 which make up lower end LE and upper ultrasonic weld 40₁. Nosepiece section NS is defined by the distance between upper ultrasonic weld 40₁ and sleeve ultrasonic weld 42. Upper section US is defined by the distance between sleeve ultrasonic weld 42 and upper end UE.

FIG. 5B is a cross sectional view of mask 200 take along line 5B-5B shown in FIG. 4A. Specifically, FIG. 5B is an exaggerated cross section view of mask 200 to properly illustrate the layering and positioning of the various components. Mask 200 includes all of the aforementioned structural components of mask 100 discussed in view of FIG. 5A in addition to specific structural components of mask 200. Focusing on the additional components that make up mask 200, most notably is window 60. Window 60 in a preferred embodiment is fixed to external surface 11 of first outer layer 10 of mask 200 via window ultrasonic weld 48, as shown. Window ultrasonic weld 48 is a continuous weld that is arranged to circumscribe the external boundaries of window 60. Mask 200 also includes aperture 12 of first outer layer 10, aperture 22 of second outer layer 20, and aperture 32 of inner layer 30. Window ultrasonic weld 48 also fixes the external boundaries of apertures 12, 22, and 32 such that there are no non-filtered areas around apertures 12, 22, 32, and window 60. Window 60 is a non-filtration component, that is, it does not have any porosity. Window ultrasonic weld 48 allows mask 200 to have the same efficacy as mask 100 despite the presence of apertures 12, 22, and 32 within first outer layer 10, second outer layer 20, and inner layer 30, respectively.

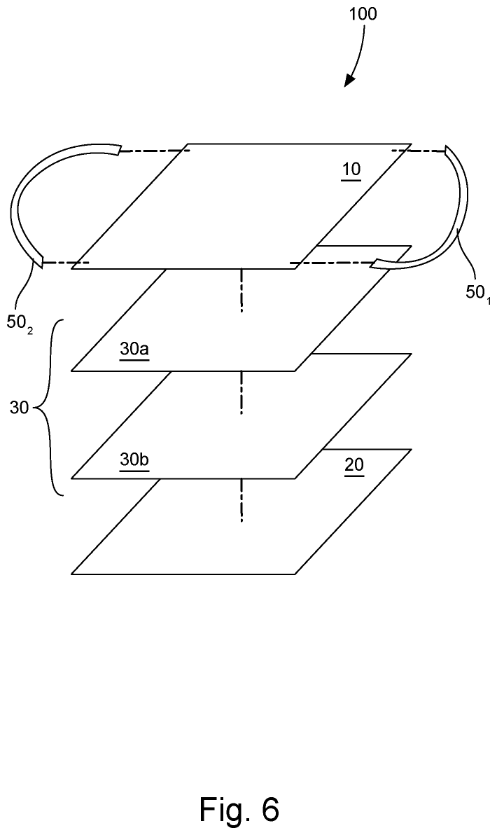

FIG. 6 is an exploded view of mask 100. Mask 100 comprises four layers, first outer layer 10 made of PP, second outer layer 20 made of PP, and inner layer 30 comprising a laminated combination of PP layer 30a and PTFE layer 30b. Ear loops 50i and 50₂ are fixed to the external surface of first outer layer 10 by ultrasonic welds, as discussed supra.

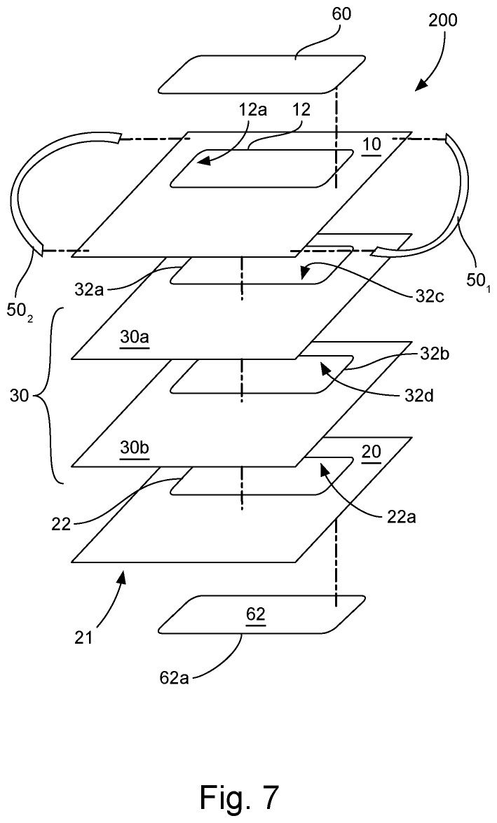

FIG. 7 is an exploded view of mask 200. Mask 200 comprises four layers, first outer layer 10 made of PP, second outer layer 20 made of PP, and inner layer 30 comprising a laminated combination of PP layer 30a and PTFE layer 30b. Each of the aforementioned layers comprise an aperture. First outer layer 10 includes aperture 12, second outer layer includes aperture 22, PP layer 30a of inner layer 30 includes aperture 32a, and PTFE layer 30b includes aperture 32b. Apertures 12, 22, 32a, and 32b are colinearly aligned. Ear loops 50₁ and 50₂ are fixed to the external surface of first outer layer 10 by ultrasonic welds, as discussed supra, by any other viable attachment method for textiles. Window 60 is fixed to the external surface of first outer layer 10 by an ultrasonic weld, discussed supra. Window 60 in a preferred embodiment is made of polyethylene. Window 60 may comprise 99.79% polyethylene and 0.21% of another suitable additive that may vary in manufacturing. In a preferred embodiment, window 60 is a Poly Expert® PEX-972-CLEAR-HS/Antifog polyethylene and is Food and Drug regulation 21 C.F.R. 177.1520 compliant. Window cover 62 in a preferred embodiment is arranged to be removably attached, e.g., by perforation, to inside rims 12a, 32c, 32d, and 22a of apertures 12, 32a, 32b, and 22, respectively. Window cover 62 is arranged to cover the surface of window 60 that faces face surface 21 of second outer layer 20. Window cover 62 keeps window 60 free from debris and sanitary before use, or alternatively, provides a shade to window 62 if transparency is unwanted.

It should be appreciated that PP layer 30a and PTFE layer 30b of inner layer 30 are shown as separate layers in FIGS. 6 and 7 representatively, as PP layer 30a and PTFE layer 30b are laminated together and may only be separated by forcible removal, i.e., destruction of either mask 100 or mask 200. As such, apertures 32a and 32b of PFTE layers 30a and 30b shown in FIG. 7 are merely exemplary to illustrate the combination of material layers that comprise inner layer 30.

It should be understood that polypropylene (PP) is a thermoplastic polymer used in a wide variety of applications. It is produced via chain-growth polymerization from the monomer propylene. PP fabric is a non-woven fabric and may be electrostatically charged to improve filtration of air particulates that would pass through a PP sheet. As such, PP is a vital raw material for producing meltblown fabric, which is, in turn, the raw material for producing facial masks.

It should also be understood that polytetrafluoroethylene (PTFE) is a fluorocarbon solid, as it is a high molecular weight compound consisting wholly of carbon and fluorine. PTFE is hydrophobic: neither water nor water-containing substances wet PTFE, as fluorocarbons demonstrate mitigated London dispersion forces due to the high electronegativity of fluorine. PTFE has one of the lowest coefficients of friction of any solid. Since PTFE is hydrophobic, face mask 100 or mask 200 of the present invention will not lose efficiency after extended use, whereas purely PP-comprised face masks will lose their electrostatic charge when worn for over four hours. An advantage of the PP and PTFE combination mask is the microporous structure that is created when it is stretched that is small enough to prevent bacteria and even virus transmission through inner layer 30 of masks 100 and 200.

The ratings of the PTFE layer and PP layer of inner layer 30 are as follows:
PTFE membrane porosity: 45-90%
PP nonwoven weight: 10-40 gsm (grams per square meter)
Inner Layer 30 thickness range: 0.5-7 microns

The ultrasonic welds, described supra, should be understood to mean techniques well known and understood by one having ordinary skill in the art of “ultrasonic soldering”. The ultrasonic welds may be a laminating process or any other suitable attachment process for textile adhesion. Alternatively, the ultrasonic welds, described supra, may be achieved by ultrasonic slitting, that is, cleanly cutting and sealing the components of mask 100 and 200, thereby eliminating the disadvantages of hot wire or rotating knives, fraying, unraveling, or beading along the cut edge.

Efficacy Standards and Results

The ASTM International, formerly known as the American Society for Testing and Materials, provides a guide assessing the appropriate face mask level for various procedures:

| | |
|---|---|
| Minimum | Ideal as a simple barrier for exams and short procedures |
| Protection | that do not produce fluid, spray or aerosols. |
| Level 1 | Ideal for procedures where low amounts of fluid, spray |
| | and/or aerosols are produced. |
| Level 2 | Ideal for procedures where low to moderate amounts of |
| | fluid, spray and/or aerosols are produced. |
| Level 3 | Ideal for procedures where moderate to heavy amounts of |
| | fluid, spray and/or aerosols are produced. |

ASTM F2100-19: Standard Specification for Performance of Materials Used in Medical Face Masks, provides for the requirements of medical face masks, which are subdivided into three categories. The threshold requirements are based on: Bacterial filtration efficiency (BFE) percentage; Particulate filtration efficiency (PFE) percentage; Splash Resistance (mmHg) pass/fail; Pressure differential (mmH₂O/cm²) ΔP; and Flammability pass/fail, as follows:

| | ASTM | ASTM | ASTM |
|---|---|---|---|
| | Level 1 | Level 2 | Level 3 |
| ASTM F2100-11 Standards | Mask | Mask | Mask |
| Fluid Resistance, mmHg | 80 | 120 | 160 |
| BFE % | ≥95% | ≥98% | ≥98% |
| PFE %, @ 0.1 micron | ≥95% | ≥98% | ≥98% |
| Delta P, mm H20/cm2 | <4.0 | <5.0 | <5.0 |
| Flame Spread | Class 1 | Class 1 | Class 1 |

The following charts show the testing data of mask 100. It should be appreciated that mask 100 may comprise two different levels of efficacy, ATSM F2100-19/Level 2 Compliant or ATSM F2100-19/Level 3 Compliant. The applicable testing data of mask 100 are shown in summation, below:

| ASTM F2100-19/LEVEL | | SPECIFI- | |
|---|---|---|---|
| 2 COMPLIANT | METHOD | CATION | RESULT |
| Bacterial filtration | ASTM F2101 | ≥98 | 100 |
| efficiency (BFE), % | | | |
| Particulate filtration | ASTM F2299 | ≥98 | 98.33 |
| efficiency (PFE), % | | | |
| Splash Resistance (mmHg) | ASTM F1862 | 120 | Pass |
| Pressure differential | EN 14683:2019 - | <6.0 | 3.73 |
| (mmH2O/cm2) ΔP | Annex C | | |
| Flammability | 16 CFR PART | Class 1 | Pass |
| | 1610 | | |

| ASTM F2100-19/LEVEL | | SPECIFI- | |
|---|---|---|---|
| 3 COMPLIANT | METHOD | CATION | RESULT |
| Bacterial filtration | ASTM F2101 | ≥98 | 100 |
| efficiency (BFE), % | | | |
| Particulate filtration | ASTM F2299 | ≥98 | 99.47 |
| efficiency (PFE), % | | | |
| Splash Resistance (mmHg) | ASTM F1862 | 160 | Pass |
| Pressure differential | EN 14683:2019 - | <6.0 | 5.15 |
| (mmH2O/cm2) ΔP | Annex C | | |
| Flammability | 16 CFR PART | Class 1 | Pass |
| | 1610 | | |

The following charts show the testing data representation mask 200. It should be appreciated that mask 200 may comprise two different levels of efficacy, ATSM F2100-19/Level 2 Compliant or ATSM F2100-19/Level 3 Compliant. The applicable testing data of mask 200 are shown in summation, below:

| ASTM F2100-19/LEVEL | | SPECIFI- | |
|---|---|---|---|
| 2 COMPLIANT | METHOD | CATION | RESULT |
| Bacterial filtration | ASTM F2101 | ≥98 | 100 |
| efficiency (BFE), % | | | |
| Particulate filtration | ASTM F2299 | ≥98 | 98.33 |
| efficiency (PFE), % | | | |
| Splash Resistance (mmHg) | ASTM F1862 | 120 | Pass |
| Pressure differential | EN 14683:2019 - | <6.0 | 3.73 |
| (mmH2O/cm2) ΔP | Annex C | | |
| Flammability | 16 CFR PART | Class 1 | Pass |
| | 1610 | | |

| ASTM F2100-19/LEVEL | | SPECIFI- | |
|---|---|---|---|
| 3 COMPLIANT | METHOD | CATION | RESULT |
| Bacterial filtration | ASTM F2101 | ≥98 | 100 |
| efficiency (BFE), % | | | |
| Particulate filtration | ASTM F2299 | ≥98 | 99.47 |
| efficiency (PFE), % | | | |
| Splash Resistance (mmHg) | ASTM F1862 | 160 | Pass |
| Pressure differential | EN 14683:2019 - | <6.0 | 5.15 |
| (mmH2O/cm2) ΔP | Annex C | | |
| Flammability | 16 CFR PART | Class 1 | Pass |
| | 1610 | | |

Canada no longer follows the ASTM International standards and instead follows new guidance from Health Canada, both mask 100 and mask 200 comply with Health Canada guidelines. Mask 200 also complies with the National Institute for Occupational Safety and Health for medical grade face masks with a transparent window. Mask 200 was also tested for bacterial cleanliness and cytotoxicity per the International Organization for Standardization, ISO 10993-5 and ISO 10993-10 for medical devices and mask 200 passed both tests. ISO 10993-5 tests relate to the incubation of cultured cells in contact with a device and/or extracts of a device either directly or through diffusion. 10993-10 tests relate to the assessment of medical devices and their constituent materials with regard to their potential to induce skin sensitization.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

10 First outer layer of face mask 100, 200
11 External surface of first outer layer 10
12 Aperture of first outer layer of face mask 200
12a Internal rim of aperture 12
14 Upper end of first outer layer of face mask 100, 200
16 Lower end of first outer layer of face mask 100, 200
20 Second outer layer of face mask 100, 200
21 Face surface of second outer layer 20
22 Aperture of second outer layer of face mask 200
22a Internal rim of aperture 22
24 Upper end of second outer layer of face mask 100, 200
26 Lower end of second outer layer of face mask 100, 200
25 Inner layer of face mask 100, 200
30a PP layer of inner layer 30 of face mask 100, 200
30b PTFE layer of inner layer 30 of face mask 100, 200
32 Aperture of inner layer of face mask 200
32a Aperture of PP layer 30a of inner layer 30 of face mask 200
32b Aperture of PTFE layer 30b of inner layer 30 of face mask 200
32c Internal rim of aperture 32a
32d Internal rim of aperture 32b
34 Upper end of inner layer of face mask 100, 200
36 Lower end of inner layer of face mask 100, 200
40 Ultrasonic weld
40₁ Upper ultrasonic weld
40₂ First side ultrasonic weld
40₃ Second side ultrasonic weld
40₄ Lower ultrasonic weld
42 Sleeve ultrasonic weld
44₁ Ear loop ultrasonic weld
44₂ Ear loop ultrasonic weld
44₃ Ear loop ultrasonic weld
44₄ Ear loop ultrasonic weld
48 Window ultrasonic weld
50₁ Ear loop
50₂ Ear loop
60 Window
62 Window cover
70 Nosepiece
72 Nosepiece sleeve
74 Pocket of nosepiece sleeve 72
80 Lower boundary panel
82 Connecting panel
84 Upper boundary panel
86 Window panel
100 PTFE and PP combination face mask
200 PTFE and PP combination face mask with transparent window
P1-P6 Pleats of mask 100
P1′-P6′ Pleats of mask 200
L1-L6 Pleat lines of mask 100
L1′-L6′ Pleat lines of mask 200
LE Lower end
UE Upper end
FS Filtration section
NS Nose section
US Upper section
PD Proximal depth
ID Intermediate depth
DD Distal depth

What is claimed is:

1. A face mask, comprising:
a first polypropylene outer layer;
a second polypropylene outer layer;
a combination polytetrafluoroethylene and polypropylene inner layer arranged between said first and second polypropylene outer layers; and,
at least one strap fixed to an outside surface of one of said outer layers.

2. The face mask recited in claim 1 further comprising:
a first weld arranged to fuse an outside perimeter of said outer layers and said inner layer, said first weld is further arranged to pleat said outer layers and said inner layer;
a flexible nose piece, said flexible nose piece secured within a sleeve, said sleeve formed by a fold of said first outer layer, said inner layer and said second outer layer to either an external surface of said first outer layer or an external surface of said second outer layer via a sleeve weld.

3. The face mask recited in claim 2, wherein said first weld and said sleeve weld are provided by ultrasonic welding techniques.

4. The face mask recited in claim 2, wherein said first weld includes a pair of horizontal welds and a pair of vertical welds, said pair of horizontal welds arranged proximate to a pair of horizontal and parallelly arranged external borders of said mask, said pair of vertical welds arranged proximate to a pair of vertical and parallelly arranged external borders of said mask, said pair of vertical welds further arranged to pleat said outer layers and said inner layer.

5. The face mask recited in claim 1, wherein the combination of said first polypropylene outer layer, second polypropylene outer layer, and said combination polytetrafluoroethylene and polypropylene inner layer have a bacterial filtration efficiency (BFE) of 100%.

6. The face mask recited in claim 1, wherein the combination of said first polypropylene outer layer, second polypropylene outer layer, and said combination polytetrafluoroethylene and polypropylene inner layer have a particulate filtration efficiency (PFE) of greater than 98%.

7. The face mask recited in claim 1, wherein the combination of said first polypropylene outer layer, second polypropylene outer layer, and said combination polytetrafluoroethylene and polypropylene inner layer have a particulate filtration efficiency (PFE) of greater than 99%.

8. A face mask, comprising:
a first polypropylene outer layer having an aperture;
a second polypropylene outer layer having an aperture;
a combination polytetrafluoroethylene and polypropylene inner layer having an aperture arranged between said first and second polypropylene outer layers;
a transparent window arranged to overlap said apertures of said outer layers and said inner layer, said transparent window fixedly secured to an external surface of said first polypropylene outer layer; and,
at least one strap fixed to an external surface of one of said outer layers.

9. The face mask recited in claim 8 further comprising:
a first weld arranged to fuse an outside perimeter of said outer layers and said inner layer, said first weld is further arranged to pleat said outer layers and said inner layer;
a second weld arranged to fuse said transparent window to said external surface of said first polypropylene outer layer or said external surface of said second polypropylene outer layer, said second weld arranged to fuse said outer layers and said inner layer about an outside perimeter of said apertures of said outer layers and said aperture of said inner layer; and,
a flexible nose piece, said flexible nose piece secured within a sleeve, said sleeve formed by a fold of said first outer layer, said inner layer and said second outer layer to either an external surface of said first outer layer or an external surface of said second outer layer via a sleeve weld.

10. The face mask recited in claim 8, wherein said first weld includes a pair of horizontal welds and a pair of vertical welds, said pair of horizontal welds arranged proximate to a pair of horizontal and parallelly arranged external borders of said mask, said pair of vertical welds arranged proximate to a pair of vertical and parallelly arranged external borders of said mask, said pair of vertical welds further arranged to pleat said outer layers and said inner layer.

11. The face mask recited in claim 10, wherein said pair of vertical welds pleat said outer layers and said inner layer in a manner that creates four panels having three different levels of depth, said levels of depth include a distal depth, an intermediate depth, and a proximate depth.

12. The face mask recited in claim 11, wherein said four panels comprise:
a lower boundary panel, said lower boundary panel arranged at said proximate depth;
an upper boundary panel, said upper boundary panel arranged at said intermediate depth;
a connecting panel, said connecting panel arranged at said intermediate depth; and,
a window panel comprising said apertures of said outer layers and said inner layers, said window panel comprising said window, said window panel arranged at said distal depth,
wherein said upper boundary panel is integrally connected to said window panel, said window panel is integrally connected to said connecting panel, said connecting panel is integrally connected to said lower boundary panel.

13. The face mask recited in claim 9, wherein said first weld, said second weld and said sleeve weld are provided by ultrasonic welding techniques.

14. The face mask recited in claim 8, wherein the combination of said first polypropylene outer layer, second polypropylene outer layer, and said combination polytetrafluoroethylene and polypropylene inner layer have a bacterial filtration efficiency (BFE) of 100%.

15. The face mask recited in claim 8, wherein the combination of said first polypropylene outer layer, second polypropylene outer layer, and said combination polytetrafluoroethylene and polypropylene inner layer have a particulate filtration efficiency (PFE) of greater than 98%.

16. The face mask recited in claim 8, wherein the combination of said first polypropylene outer layer, second polypropylene outer layer, and said combination polytetrafluoroethylene and polypropylene inner layer have a particulate filtration efficiency (PFE) of greater than 99%.

17. The face mask recited in claim 8, wherein said transparent window is made of polyethylene.

18. The face mask recited in claim 17, wherein said transparent window comprises approximately 99.79% polyethylene.
